(19) United States
(12) Patent Application Publication
(10) Pub. No.: US 2007/0159655 A1
(43) Pub. Date: Jul. 12, 2007

(54) Method and apparatus for compensating two-dimensional images for illumination non-uniformities

(75) Inventor: Chengwu Cui, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/329,638

(22) Filed: Jan. 11, 2006

(51) Int. Cl. H04N 1/40

(52) U.S. Cl. 358/3.01

(57) ABSTRACT

A method is provided for compensating two-dimensional images for non-uniformity variations in the illumination of a document, or a scene, that is acquired by a digital camera. The invention can include a printer and/or a personal computer to perform some or all of the compensation calculations, if desired. The present invention captures initial image data, determines a region or area of that data having substantially, or somewhat, uniform pixel intensities and uses that as a background or border region. This border data is used to calculate correction data to correct or compensate the non-border pixel values for non-uniformities in the illumination of the image when it was first acquired, without needing a separate reference frame.

### TECHNICAL FIELD

The present invention generally relates to image acquiring equipment and is particularly directed to a two-dimensional imaging device of the type which includes an array of photosensitive elements to acquire multiple pixel values of a two-dimensional image, such as a document. The invention is specifically disclosed as a method for compensating two-dimensional images for non-uniformity variations in the illumination of a document, or a scene, that is acquired by a digital camera. The invention can include a printer and/or a personal computer to perform some or all of the compensation calculations, if desired.

### BACKGROUND OF THE INVENTION

Image data acquired by photosensors may be in a single dimension, or in two dimensions. Image scanners typically acquire image data in a single dimension (“1-D” data), using a movable scan bar. The scan bar starts at a predetermined “X” position (along the left edge of a document, for example), and the multiple photosensors acquire pixel image data for multiple “Y” positions, in which the X-direction and Y-direction are perpendicular to one another. The end effect is a set of two-dimensional (“2-D”) data, however, the actual scanning device only acquires image pixels in a single dimension (e.g., the Y-direction in the above example), then moves to a new position (e.g., in the X-direction in the above example) to take another sample of the document (e.g., again in the Y-direction in the above example).

Most conventional image scanners are capable of compensating for variations in lighting conditions within the scanning device itself, or even for variations in the image-acquiring photosensor sensitivities. This can be accomplished by positioning the scan bar over a known “white area” of the scanner, turning on the light source, and acquiring a line of pixel image data from that white area. In theory, all of the thusly-acquired pixels will have exactly the same brightness and color values, since the white area should be substantially clean and of the same color, and since the multiple photosensors should have substantially the same sensitivity. However, such a “perfect” set of photosensors may be costly, and in any event they really are not necessary—the scanner is capable of inspecting the acquired pixel values and then “immediately” (i.e., in real time) compensating the variations in those acquired pixel values by adding or subtracting “compensation data” for each of the pixel positions. In this manner, the scanner can simultaneously compensate for variations in the scanner's light source and in the scanner's scan bar photosensor individual sensitivities. In essence, the initial scan of the known area acts as reference data that can be inspected to look for variations in the brightness or intensity values that are detected by the individual pixel photosensors. Such variations are then corrected or compensated for by introducing a correction factor, or an added or subtracted amount, for example, for each of the individual pixel locations. Thereafter, when the document of interest is scanned by the scan bar, these compensation values are applied to the acquired data for each pixel location in the Y-direction.

On the other hand, if a two-dimensional device, such as a digital camera, is used to acquire image data, then there may not be a “known area” (e.g., some type of two-dimensional area of substantially known, or at least substantially constant, color throughout) available for use in compensating for variations in lighting, or for variations in the sensitivity of the individual photosensors that acquire the pixel data. Even if a known area is available, the conventional methods for compensating for variations in lighting require a first, reference frame to be acquired by the digital camera to allow the camera to determine what the 2-D compensation data values should be for the various 2-D pixel positions in the photosensor array. It should be noted that such 2-D compensation data will be used mainly to compensate for variations in lighting, rather than to compensate for variations in individual photosensor sensitivities. (The “known area” and the lighting, as well as the camera set-up, would have to be virtually perfect in order to use the compensation data to correct for the individual 2-D photosensor sensitivities. Therefore, for the purposes of this description, it will be assumed that the 2-D compensation data is mainly used to compensate for variations in the lighting of the object that is being imaged.)

Various conventional methods for compensating for 2-D image data are known in the patent literature. The following patent documents are examples of such methods: U.S. Pat. No. 4,933,983; U.S. Pat. No. 5,786,902; U.S. Pat. No. 5,856,864; U.S. Pat. No. 6,064,759; U.S. Pat. No. 6,211,940; U.S. Pat. No. 6,219,153; U.S. Pat. No. 6,837,432; and published patent applications US 2003/0085280 A1 and US 2003/0089778 A1.

### SUMMARY OF THE INVENTION

Accordingly, it is an advantage of the present invention to provide a digital image scanning system using a two-dimensional scanning element, such as a digital camera.

It is another advantage of the present invention to provide a two-dimensional digital scanning system in which a digital camera is used to acquire an image, and later digital processing is performed to correct or compensate for non-uniformity in the illumination of the image as it was being scanned.

It is a further advantage of the present invention to provide a digital scanning system using a two-dimensional scanning device such as a digital camera to acquire a digital image, then analyze portions of the scanned image to find special areas such as border regions, and use the illumination values for these border regions to determine compensation data that can be applied throughout the two-dimensional image and thus compensate for non-uniformities in the illumination of the original image.

Additional advantages and other novel features of the invention will be set forth in the description that follows and will become apparent to those skilled in the art upon examination of the following or may be learned with the practice of the invention.

To achieve the foregoing and other advantages, and in accordance with one aspect of the present invention, a method for compensating two-dimensional image data is provided, in which the method comprises receiving an initial image comprising two-dimensional image data and determining a first set of data that comprises a first plurality of pixels at various grid locations within a first region of the two-dimensional image data; analyzing the first set of data for variations in illumination values of the first plurality of pixels, and determining relative non-uniformities of intensity in the first set of data based upon the illumination values; determining a set of initial compensation data used in correcting for the relative non-uniformities of intensity in the first set of data, wherein the set of initial compensation data includes both intensity correction values and corresponding grid location information for at least a portion of the first set of data; and applying the set of initial compensation data to the two-dimensional data, including second portions of the two-dimensional data that are not part of the first set of data using only information based upon the initial image.

In accordance with another aspect of the present invention, a method for compensating two-dimensional image data is provided, in which the method comprises receiving an initial image comprising two-dimensional image data and determining locations of a first plurality of pixels for a border region of the initial image; determining illumination non-uniformities of the first plurality of pixels based upon variations in image data intensity values of the first plurality of pixels; determining compensation data for a second plurality of pixels, located in a non-border region of the initial image, based upon the illumination non-uniformities of the first plurality of pixels; and applying the compensation data to the second plurality of pixels, to thereby create a third plurality of pixels that are substantially compensated for non-uniformities in illumination of the initial image, using only information based upon the initial image.

In accordance with yet another aspect of the present invention, a method for compensating two-dimensional image data is provided, in which the method comprises receiving an initial image comprising two-dimensional image data and determining first compensation data for a border region of the initial image; determining second compensation data for a non-border region of the initial image by extrapolating the first compensation data into the non-border region; and applying the first compensation data to the border region and applying the second compensation data to the non-border region, thereby substantially compensating for non-uniformities in illumination of all portions of the initial image using only information based upon the initial image.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a diagrammatic view of a two-dimensional (2-D) image, in which there are border regions along all four perimeter sides, and one border pixel value is taken at each corner.

FIG. 2 is a diagrammatic view of a 2-D digital image, in which there are four borders along each of the perimeter sides, in which multiple pixel values are taken along each border region.

FIG. 3 is a diagrammatic view of a 2-D digital image, in which there are border regions along only three of the four perimeter sides, and in which a single border pixel is taken near each of the four corners.

FIG. 4 is a block diagram of some of the major components used in the present invention, including a digital camera and a printer.

FIG. 5 is a flow chart showing some of the logical operations used in the present invention.

FIG. 6 is a flow chart showing some other of the logical operations used in the present invention.

### DETAILED DESCRIPTION

Reference will now be made in detail to the one exemplary embodiment of the present invention, an example of which is illustrated in the accompanying drawings, wherein like numerals indicate the same elements throughout the views.

A digital camera is essentially a scene digitizer, and when used to photograph a document, it can become a document scanner. Using a digital camera as a scanner possesses many advantages over traditional flatbed or sheet fed scanners, including the convenience of upward facing scanning, no requirement for motorized parts in such a scanner, and potentially better scanner performance by use of an array of light-detecting sensors. However, one potential problem in such a scanning system is that the lighting condition may cause variations, or non-uniformity in the illumination, both in the diffuse form and in the specular form. This may occur either when the lighting (or illumination) is provided exclusively by normal ambient light, or by a combination of ambient lighting and a camera flashlight.

Illumination non-uniformity in the diffuse form will create false density variations in the acquired image of a document and later can be mistaken as the original background in a document. When a glossy document is photographed, the reflective images of the illumination source will be imposed on the document, sometimes saturating the sensors and creating “digital glare” that will make part of the document image appear whitened out, and illegible.

When a human reads a document, the illumination condition may essentially be the same as described above when a digital camera is used. However, the human visual system overcomes the same problems in two different ways: (1) The human visual system can adapt to illumination variations and become insensitive to non-uniformity in the diffuse form in subsequent neural processing, or (2) to overcome specular reflections, the human visual system may avert the glare source by tilting either the person's head or the document.

The present invention generally comprises a method for compensating non-uniform illumination intensity distributions for scanning images or documents using an imaging sensor, such as a digital camera. The invention extracts the equivalent of a reference frame from the initial scanned image data, without needing to acquire a separate image that otherwise would be used as the reference frame.

In one mode of the present invention, the initial scanned image data is inspected to derive a special set of data, such as a border set of data. This border set of data is then used to determine a set of initial compensation data (e.g., correction factors, or additive or subtractive correction values) for correcting non-uniformities in the illumination values of the border region pixels. Once the initial compensation data has been determined for the border region pixels, this data can be extrapolated for other regions of the 2-D image that was acquired as the initial image data. The present invention thus first determines the border region (initial) compensation data, and then uses that information to determine the non-border region compensation data, thereby generating compensation data for the entire 2-D image from a single frame (i.e., the initial frame) of image data.

In another mode of the present invention, the initial compensation data is not only used for the border region grid positions of the image data, but also for the non-border region grid positions of the same image data. This can occur for various types of images, such as those that contain relatively simple 2-D shapes and relatively smooth variations in colors and color intensities. Alternatively, this type of image processing can be mandated for relatively simple digital camera and printing systems, in which either the amount of memory is limited, or the amount of processing power is limited. In such situation, the initial compensation data could be automatically extrapolated over the entire area of the 2-D image data, regardless of whether the system knows that certain pixel or grid locations are within a border region or not.

In a further mode of the present invention, when the initial scanned image data is inspected to derive the border set of data, every pixel position could be inspected if the processing power and the amount of memory are both sufficient to do so. This would typically be a preferred mode of operation. However, it may not be necessary to literally inspect each and every pixel, and instead only a sample of the pixels could be inspected, if desired. For greater accuracy, the sample of pixels inspected should be a large sample (i.e., the closer to 100% of samples inspected, the more accurate the results). On the other hand, if the processing power and/or the available memory space is somewhat limited, then the sampling method may be necessary, even though accuracy may be sacrificed to a certain degree. A random sampling might be used, or perhaps a sampling technique which alters the frequency of samples taken at or near locations where “interesting” pixel illumination data is found. All of these possibilities are contemplated by the present invention.

The sampling technique for inspecting pixels proximal to an edge of the image could involve decisions on both the number of pixel positions to be sampled and the pattern of this sampling. The present invention can use truly random sampling of patterns, assuming a predetermined number of pixel positions to be taken, or perhaps a pseudo-random sampling of the number of pixels to be taken, assuming a predetermined type of pattern of pixels is to be sampled. Alternatively, the pixels to be inspected may be of a predetermined, non-random sampling of both patterns and numbers of pixel positions.

It will be understood that the terms pixel position, pixel location, grid position, and grid location are substantially synonymous as applied to two-dimensional image data and the present invention. Moreover, while grid positions are typically thought of as being in perpendicular directions (e.g., an X-axis and a Y-axis) when applied to image data, grid positions could instead refer to a polar coordinate system, if desired, without departing from the principles of the present invention. Of course, most image scanners use an orthogonal set of photosensitive devices (e.g., CCD elements), and most printing systems print in a “process direction” or a “scanning direction,” but also have a media movement direction, often referred to as a “sub-scanning direction” that are essentially perpendicular from one another. Finally, the very first image data that is acquired could be in three dimensions (“3-D”) for some imaging devices (e.g., stereoscopic cameras), and then a set of 2-D data could be extrapolated from that 3-D data to become the initial image data referred to herein.

Assuming the illumination intensity distribution on the document plane being scanned is E(i,j), where “i” and “j” denote the position coordinates in terms of pixel location in the image acquired by the scanner, E(i,j) can be extracted in a number of ways. Once extracted, it can be used for compensating the non-uniformity in the illumination of the image, with pixel by pixel resealing and normalizing operations. In the present invention, one benefit is to provide the capability for extracting or acquiring E(i,j) during a single scanning operation, thus without excessive burden to the user or to the user's imaging system, which will also provide timely illumination information. In this description, the terms “image,” “initial image,” “scanned,” or “scanning” are used for consistency, whether a single frame of a digital image is used, or a stitched frame is used that consists of a number of smaller frames and are stitched together into a single frame or image.

The non-uniformity in illumination of most objects is ubiquitous in the visual environment, and this illumination non-uniformity is a form of noise that the human visual system has evolved to ignore by desensitizing the perception of low spatial frequency signals and other adaption. A typical human's contrast sensitivity function exhibits a fairly low sensitivity at the lower end of spatial frequency, particularly compared to the higher sensitivity in the middle level of spatial frequencies. This type of characteristic in the human visual system implies that most illumination variations or non-uniformities are of low spatial frequencies in nature. However, an array of light sensitive elements, such as a CCD array used in a digital camera, will acquire the non-uniformity information regardless of the actual spatial frequencies, and typically it is difficult to separate such variations from the background of the image when performing subsequent image processing.

In the present invention, a digital camera can be used to acquire a two-dimensional image of virtually any type of object, and the present invention is particularly useful for taking digital camera images of documents that are resting on a surface, such as a desk or table. It would be ideal to use a direct frame of a perfect white surface to use as a reference frame, which could be used to characterize the illumination on the document. However, such an extra operation would typically be an unwelcome burden to the user. The present invention makes it possible to automatically extract a reference frame from the initial image that is acquired of the document itself, thereby eliminating the need to also acquire a separate reference frame, such as a separate image that is scanned over a perfect white surface.

If an ideal reference frame is to be imaged, it most likely should be taken with a uniform surface having a similar surface property as that of the document that will later be imaged. For example, if the document is marked or printed on a particular type of white paper, then the ideal reference frame should be taken using that same white paper. In many practical applications, it is possible to have two modes of operation for a system that uses a digital camera for taking two-dimensional images. In a first example mode, the document that is to be scanned does not have a media background, such as a borderless photograph. A second example mode is where a three-dimensional object is to be scanned, which can be referred to as a picture mode. In this second mode, the scanned image is often busy in spatial content, and illumination non-uniformity will likely have minimal visual impact on the scanned image. Thus, in that situation, compensating for illumination non-uniformity may not be necessary.

In a third mode using the digital camera as the image acquiring tool, a document having some type of background area, such as one or more borders or margins, may be scanned. This would be true for most paper documents that have been printed or typed on, even such paper documents that have graphic-type artwork, or photographic data, that have been halftoned. This third mode of operation can be referred to as a “document” mode. Note that, even when scanning a 3-D object in the picture mode, if the field of view of the digital camera is sufficiently large to cover a document support platform (e.g., a table or desk), then that document support platform could have a uniform matt white surface, and that overall image could then be categorized as being acquired in the document mode.

The present invention exploits the existence of background regions or border areas of 2-D images that are acquired by a device such as a digital camera, when operating in the above-noted document mode. For example, the background regions could comprise bright sky areas in a photograph or bright areas in a computer-generated graphic image. This invention also exploits the fact that illumination non-uniformity typically is of low spatial frequency, and the present invention extracts the essence of a reference illumination frame without actually acquiring a separate image that otherwise could be used as a reference frame. As such, the present invention acts as a real-time frame extraction approach, which also can account for temporal illumination variations, such as when a weather change occurs in which clouds pass over the site. Another example is where a user or another person blocks a path of light and casts shadows on the document while the image is acquired.

Referring now to FIG. 1, the acquired image is generally referred to by the reference numeral 10 and exhibits a border region around each of the four perimeter edges. In one exemplary embodiment, image acquiring equipment could take a set of pixels within the border regions, such as the four pixels near the four corners, referred to on FIG. 1 as pixel locations B1-B4. This of course is a very simplistic example, and is used only for purposes of describing the present invention in greater clarity. Inside the border areas are other portions of the acquired image, and these other non-border pixel locations will be referred to on FIG. 1 as pixel locations P1-P9.

It will be understood that the present invention can be used with monochrome images or color images, and there can be any number of color planes that are desired by the user. Most digital camera systems will have at least three color planes. Moreover, most printing systems have either three color planes (cyan, magenta, yellow) or four color planes (cyan, magenta, yellow, and black).

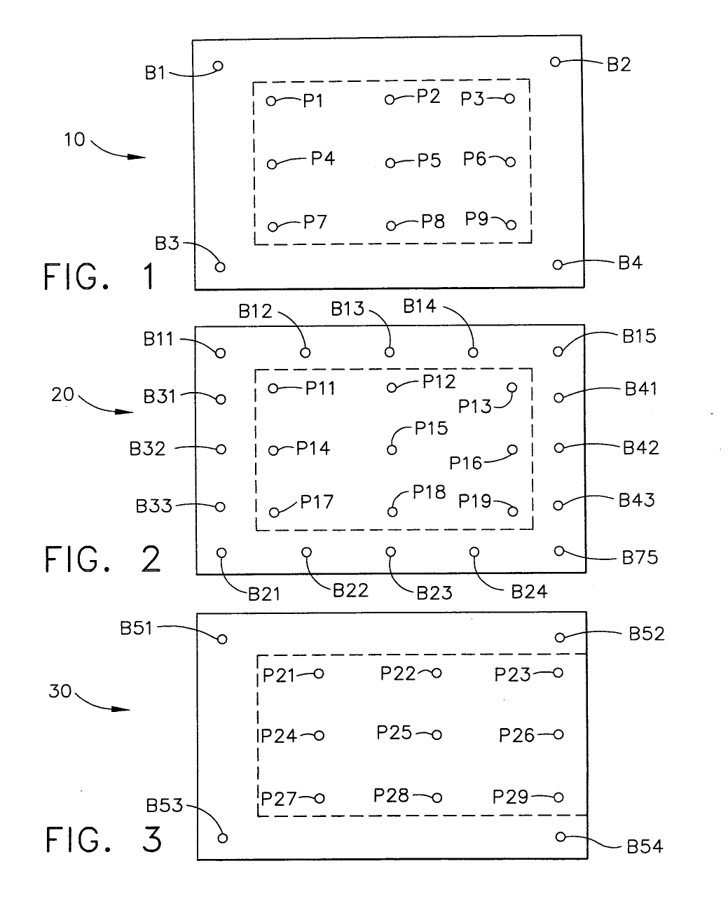

In the present invention, it will be likely that a large number of border pixel illumination values and grid positions will be sampled to determine appropriate compensation data. FIG. 2 shows an example of an acquired image, generally referred to by the reference numeral 20, which has three additional border pixels taken along each of the four perimeter sides, or edges. In FIG. 2, the border pixels are referred to as B11-B15, B21-B25, B31-B33, and B41-B43. These illustrated border pixels are all considered to be proximal to one of the image edges.

On FIG. 2, there are also illustrated nine non-border pixels, referred to as P11-P19. Each of the border pixels would be sampled for its raw data, and typically it would be assumed that each of the border pixels should be compensated to have the identical value. For example, if the border pixels are assumed to be at an ideal value of pure white, the compensated value would be 255. After knowing the raw pixel values and the ideal pixel values (or perhaps knowing the proper compensation values) for the border pixels, corresponding compensation values for the non-border pixels can then be calculated based upon their grid positions in the image data 20.

Referring now to FIG. 3, the image data is generally referred to by the reference numeral 30. There are border pixels, as before, however when sampling the pixels along the edges of the image, only three of the perimeter edges were found to have a feature that could be referred to as a border for the purposes of the present invention. The pixel positions B51 and B53 could correspond to the pixel positions B1 and B3 in FIG. 1. However, the other two “corners” of FIG. 3 would not directly correspond to the same corner pixels B2 and B4 of FIG. 1.

In FIG. 3, these non-corner border pixels are referred to as B52 and B54. Non-uniform illumination compensation factors can nevertheless be calculated, because there is some border-type image data near the top and bottom of the right edge of the image data 30. This can provide a rough approximation as to whether the non-border pixels P23, P26, and P29 need to be brightened, and to what degree (i.e., by what amount), based on their grid positions in the image data 30. All of the non-border pixels P21-P29 would then have appropriate compensation values calculated therefor. This is a very simplistic example, and many additional border pixel locations could undoubtedly be used in a practical application.

It will be understood in the examples of FIGS. 1-3, that there may be many additional non-border pixels than the nine pixel positions depicted in these three figures. In a practical application, every non-border pixel would likely have a compensation value calculated therefor, which then would be applied to each of the non-border pixel illumination values, depending upon their grid positions in the image data. Moreover, if a sufficiently powerful processing unit is available along with a sufficiently large memory, then it is likely that every border pixel position will be sampled and its illumination value and grid location stored, to thereby determine the compensation factors to be used in compensating the non-border pixels. This exact methodology is optional by the designer, and certain border pixels could be skipped, either on a uniform or a random basis, as desired by the designer, perhaps as required by a lack of processing power and memory space.

Assuming that the illumination distribution at a location (x,y) on the document plane is S(x,y), this quantity can be expressed as a two-dimensional mathematic function. One example of such a 2-D function is a Taylor polynomial. An example of a Taylor polynomial function in a general form is listed below as EQUATION #1:

$$S ( x , y ) = {\sum }_{i = 0}^{I} {\sum }_{j = 0}^{J} {S}_{ij} {x}^{i} {y}^{j}$$

If I=0 and J=0, then the illumination is perfectly uniform. A higher order function for S(x,y) can be used to account for more subtle variations. In many images, the image content will have a relatively low spatial frequency, and second order polynomials should be sufficient for most situations. It will be understood that different forms of 2-D functions (other than a Taylor polynomial) may be used in the present invention for this purpose.

As described above in connection with the image data examples of FIGS. 1-3, the present invention attempts to identify a special region or border area to derive the equivalent of a reference frame for the initial image data. In this description, the identified border area set will be referred to as B(x,y).

Once this border area set of data B(x,y) has been identified, the present invention can use that data along with a mathematical model that will tend to minimize the non-uniformities in the illumination distribution. One such mathematical model is a Taylor polynomial, in which the exponents can be as large as needed to approximate an imaging system that may have significant non-uniformities. If the exponents in such a polynomial equation need to have values of only 1 or 2, this would reduce the expression to either a linear or a quadratic equation.

For example, a first order Taylor polynomial based on EQUATION #1 would have the form:
s₁₀x+s₀₁y,
and, for example, a second order Taylor polynomial based on EQUATION #1 would have the form:
s₁₀x+s₀₁y+s₁₁xy+s₂₀x²+s₀₂y².

When attempting to derive a reference frame from the identified border area, a function “f” can be used to determine whether a selected Taylor polynomial, such as EQUATION #1, will accurately “fit” the pixel data. One type of function f that could be used is provided below in its general form as EQUATION #2:

$$f = \int \int {[ B ( x , y ) - {\sum }_{i = 0}^{I} {\sum }_{j = 0}^{J} {S}_{ij} {x}^{i} {y}^{j} ]}^{2} ⅆ x ⅆ y$$

The above function f uses a set of coefficients referred to as Sᵢⱼ, and this set of coefficients is used to minimize the result of EQUATION #2. In EQUATION #2, the actual pixel data values for the set of border pixels is B(x,y), as noted above, while the mathematical model of the image data is the Taylor polynomial, as in EQUATION #1. Standard optimization operations can be performed on this function f, such as the “least square estimator” optimization method. When using EQUATION #2 with the least square estimator optimization method, the predictive values from the Taylor polynomial are subtracted from the actual border pixel values, and the absolute value of this difference is squared and integrated over both directions of the orthogonal image grid. The goal is to find a proper set of Sᵢⱼ coefficients to minimize the numeric results for this function of EQUATION #2.

Various techniques can be employed to identify the border areas. In general, border areas should be defined as continuous neutral areas of relatively brighter pixel readings. In one technique, the search can be started from each border pixel of a frame along the outermost perimeter edge, and then work inward to the next row or column of pixels until a substantial drop of pixel luminance is encountered or until a significant change in color is encountered. For a multi-color image, the drop of the luminance can be determined using the green channel alone, for example, by measuring green pixel intensities. Alternatively, the luminance attribute of a color space metric, such as the CIELAB metric or an equivalent, could be used to determine a border area.

Once a set of coefficient values Sij has been determined, then the two-dimensional function of EQUATION #1, S(x,y) of the page can be computed. With S(x,y) known, the scanned image can then be compensated by scaling and normalizing the pixel values against the S(x,y) values, and the non-uniformity in illumination will be substantially compensated.

To describe the invention with a very simplified example, if the image has a relatively white border around all four edges, and if the top-right and top-left image values are less bright than the bottom-right and bottom-left values, then the compensation data would make all of the image data brighter closer to the top of the image than toward the bottom of the image. This was the effect described above in the example data presented in conjunction with FIG. 1. And in the present invention, this compensation can work in both the X-axis and Y-axis, without previously acquiring a separate reference frame of image data.

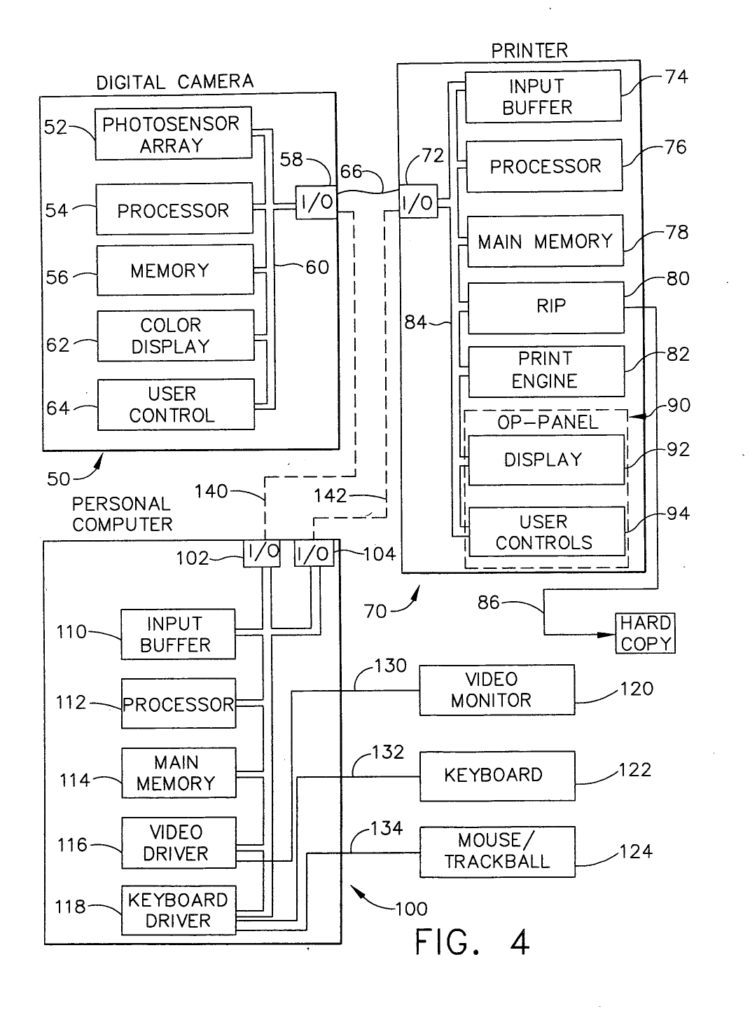

Referring now to FIG. 4, a hardware block diagram is provided showing some of the major components that can be used in the present invention. A digital camera is generally designated by the reference numeral 50 and includes a photosensor array 52, a processing circuit 54, a memory circuit 56, and an input/output (I/O) circuit 58. These circuits are electrically connected together with some type of data or address lines, or command signal lines, and all of these electrical connections are generally designated by the reference numeral 60 in the form of a bus. Also connected to these processing and memory components are a color display 62 and a set of user controls 64. Typical digital cameras have multiple user controls, to set, for example, the adjustment for wide angle or zoom lens effects, time exposure and focal length attributes.

A second element of the present invention could be a printer, generally designated by the reference numeral 70. Printer 70 has an input/output circuit 72, an input buffer 74, a processing circuit 76, and a memory circuit 78. In addition, many printers have a processing capability known as raster image processing, which is also referred to as a RIP processor, designated by the reference numeral 80 on FIG. 4. Most printers also have a print engine processing circuit, designated by the reference numeral 82 on FIG. 4. It will be understood that the RIP processor 80 and the print engine processor 82 may be separate processing devices, or they maybe combined in one processing circuit, which may also include the processor 76 on FIG. 4. Many printers use Application Specific Integrated Circuits (ASICs) to contain logic elements, input/output elements, memory elements, and even a processing circuit, all within one device. In an alternate embodiment, virtually all of the circuits described above may be contained in a single ASIC. It will be understood that the input buffer 74 could be part of a larger main memory circuit, such as the memory 78. On the other hand, the input buffer 74 could be a separate, dedicated set of memory elements or buffers. Most or all of the main hardware elements could be connected to each other via a bus 84, containing data, address, and command lines.

Most printers have some type of operator panel, which is generally designated by the reference numeral 90 on FIG. 4. In a typical printer, the op-panel 90 will include some type of display 92 and set of user controls 94. In many printers, the display 92 is an LCD device that has multiple rows and columns of alphanumeric characters, but the display may also be more sophisticated, such as a touch screen in which the user controls are embedded in the display or a display with full three-color capabilities. The user controls may be a set of push buttons and may include some type of pointing device, such as a cursor control.

Another possible component for use in the present invention is a personal computer (“PC”), generally designated by the reference numeral 100. The PC 100 will typically include multiple input/output (I/O) circuits, including the circuits 102 and 104 on FIG. 4. The signals passing through the I/O circuits 102 and 104 will typically pass through a set of signal and command lines, which could also have address lines connected thereto. All of these data, address, and command lines could be grouped as a bus, such as the bus 106 on FIG. 4.

In PC 100, the I/O circuits are connected to an input buffer 110, which may be part of the system main memory 114. A typical PC will have a microprocessor, depicted on FIG. 4 by a processing circuit 112. A typical PC will also have a video driver circuit 116 and a keyboard driver circuit 118. All of these devices are typically connected to one another by bus 106.

A typical PC will have a video monitor 120, a keyboard 122, and a pointing device 124, such as mouse or a trackball. Video monitor 120 is connected to the video driver circuit 116 over a signal line 130. Keyboard 122 is connected to the keyboard driver circuit 118 by a signal line 132. The mouse/trackball 124 is connected to some type of pointing driver circuit over a signal line 134. The mouse/trackball 124 may interface to a separate driver circuit, or to the keyboard driver circuit 118, particularly if the PC 100 is some type of portable device, such as a laptop or a personal digital assistant. These are well-known interface circuits and hardware components.

It will be understood that the digital camera 50, printer 70, and personal computer 100 could have many more components than described above or could omit some of the circuits described above while still falling within the principles of the present invention.

In the functions that are performed by the digital camera 50, the data could remain within the digital camera 50 for the purposes of some users, but many users may want to print or otherwise store this data on another device. Therefore, the digital camera I/O circuit 58 can be connected to a printer 70, through its I/O circuit 72 via a signal line 66. Printer 70 may be a standalone printer or a multifunction device capable of printing as well as performing at least one additional function, such as copying, scanning, and/or faxing. In this situation, the digital camera 50 will acquire the image and eventually transfer that image to the printer 70. The illumination compensation image processing described above could take place in either of these devices, depending on where the main processing power and memory capabilities are located. On the other hand, a PC could be used to perform these processing intensive functions, and thus the digital camera I/O circuit 58 could be connected to the PC I/O circuit 102 via a signal line 140. Moreover, if the stored image is to be printed after the image processing takes on the PC 100, then the other I/O circuit 104 of the PC can be connected to the printer I/O circuit 72 via a signal line 142.

It will be understood that the illumination compensation image processing software can be designed to work on any of the three major systems described in FIG. 4, i.e., the digital camera 50, the printer 70, or the PC 100. In addition, some of the image processing could be distributed through more than one of these major components, although that would likely require more specialized software compatible with a specific combination of these major systems. It will also be understood that the printer 70 will not necessarily need all of the processing circuits that are depicted on FIG. 4. For example, some of the processing for the RIP processor 80 and the print engine 82 could be performed on the PC 100, and the RIP processor 80 and print engine processor 82 would essentially become virtual processors with respect to the printer's hardware components. All of these options are contemplated in the present invention.

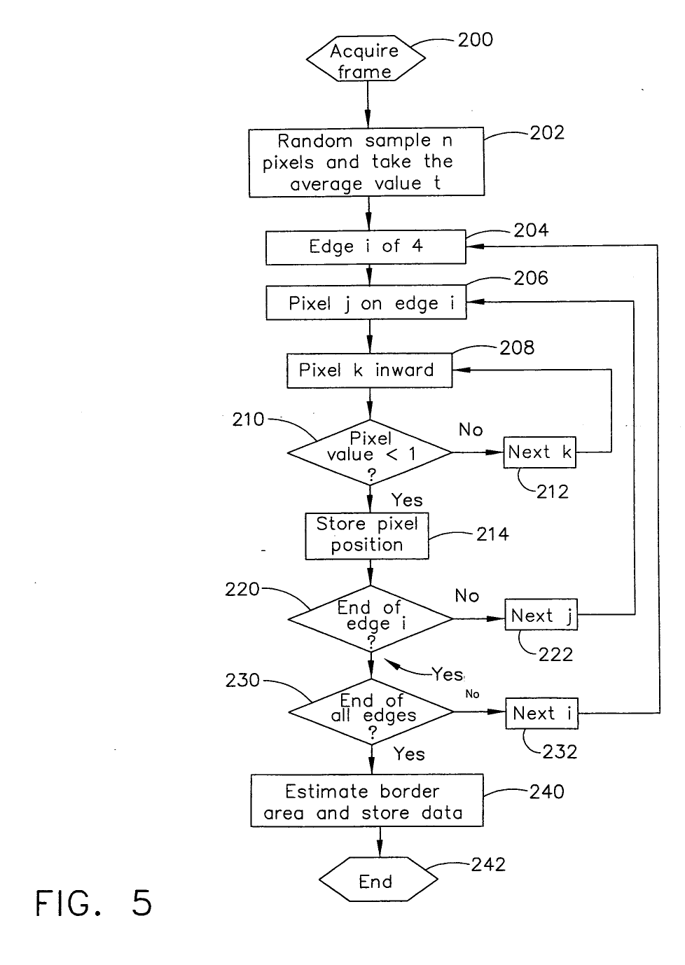

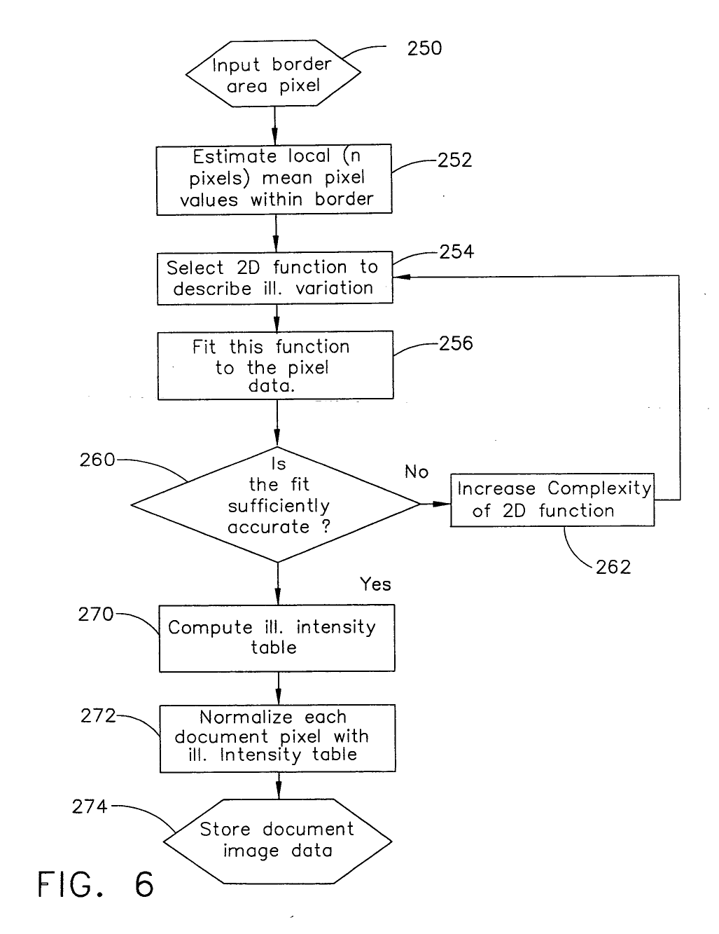

Referring now to FIG. 5, a flow chart for finding the border regions of a 2-D image is depicted, starting with block 200 in which the initial frame of image data is acquired by an input device, such as a digital camera 50. A random sample of n pixels are acquired at block 202. The average value of these n pixels is found, and that average value is referred to as the variable t. This average value t is a possible indicator of the type of image that has been acquired at the block 200. For example, a very bright or high value of t could indicate a document that is mainly a text document with very little marking materials coverage, such as toner or ink, since text documents typically only have about ten percent toner or ink coverage. On the other hand, a much darker or lower value of t may indicate that the image is some type of photograph or computer-generated graphic image that has many dots to be printed and may perhaps be a color image. If the printer is a color device, then each of the color planes can be analyzed separately in a flow chart such as that of FIG. 5.

At block 204 the number of edges, which typically would be four, is determined. Starting with the first edge, a variable i will have a value of one through four (or perhaps zero through three, if desired). At block 206, the set of pixels along the first edge i is determined. Each of the pixels along edge i is referred to as a pixel j. (These pixels j are proximal to the edge i.) As described above in reference to FIGS. 1-3, there could be as few as two pixels per edge, which would essentially be the corner (or near-corner) pixels, such as B1 and B3 on FIG. 1. On the other hand, as long as sufficient processing power and memory power is available, it is contemplated that every pixel along the edges will be analyzed, and therefore, pixel j will start at one of the corners and its position will be incremented down or over to the next corner, one pixel location at a time, for example.

At block 208, inspection of the pixel location k is accomplished by moving one row or column inward from the edge i. The increment value could be a single row or several rows to save processing power and memory space. Assuming sufficient processing power and memory space are available, the increment value would likely be a single pixel spacing for each pixel k.

Continuing the logic flow, block 210 now determines if the pixel value is less than the average value t. If the answer is NO, then the pixel location is incremented (block 212) to the next inward pixel location at block 208. On the other hand, if the pixel value is less than the average value t, then at block 214 the pixel position is stored. Note that the pixel value may also be stored at this time for future reference, or the difference between the border pixel value and the average value t; or perhaps such border pixel values and grid positions will be inspected later, after all the border region locations have actually been determined.

The logic flow now arrives at a decision block 220, which determines whether or not the processing has arrived at the end of the edge i. If not, then at block 222, the pixel position is incremented to the next j pixel along the same edge i. On the other hand, if the end of edge i has been reached, then at decision block 230, whether the processing has arrived at the end of all of the edges i is determined. If not, then at block 232, the pixel location is incremented to the next edge i. Once the end of all edges has been found, the border area is estimated, and the data is stored (block 240). Processing is complete at block 242.

The combination of blocks 208, 210, 212, 214, 220, 222, 230, 232, and 240 act to determine whether an image grid boundary for pixel values either fall within the border area (e.g., those with values greater than or equal to t) or do not fall within the border area (e.g., those with values less than t). This image grid boundary would typically represent a line along the X-axis or Y-axis of the initial image data, assuming an orthogonal coordinate system for this image data, and this X-line or Y-line becomes the effective inner edge of the border area. (The outer edge of the border area is assumed to be one or more of the perimeter edges of the image data, in this example.)

As an example, if the average value t determined at block 202 is determined to be a very bright value, such as a value of 90% of the maximum brightness value of 255 (for an 8-bit system), then the darker pixels will likely be black dots for a monochrome text image-type document. In that situation, the pixel value for a black dot will likely be much smaller than the average value t determined at block 210. The pixel values are stored for those positions, thereby determining the outer boundaries of the actual text portion of the document that was imaged by the camera and generating the initial image that was acquired at block 200. With a typical high-resolution printer, there will be hundreds if not thousands of pixel rows or columns before such dark dots are found within the data of the acquired image frame, and those hundreds or thousands of rows and columns will become the border data that will be used to generate the equivalent of a reference frame from the image data acquired in the original or initial image frame of data at block 200.

Referring now to FIG. 6, another flow chart is provided showing a process for finding a surface that fits the data acquired by inspecting the borders, as per the flow chart of FIG. 5. Beginning with block 250, the border area pixel data is retrieved. At block 252 a local mean pixel value within the border for n pixels is estimated. At block 254, a two-dimensional function that describes the illumination variation, taking into consideration the border pixel values as well as their grid positions within the image plane, is selected.

At block 256, an attempt is made to fit this two-dimensional function to the pixel data, by using one of the Taylor polynomials, for example. It is then determined whether the fit is sufficiently accurate for the actual pixel data for the border pixels (block 260). If the fit in not sufficiently accurate, the complexity of the two-dimensional function is increased at block 262. Such increase in complexity could entail using a higher order Taylor polynomial function. If, for example, the first attempt used a first order Taylor polynomial, then the second attempt could try a second order Taylor polynomial.

On the other hand, if it is found at block 260 that the fit was sufficiently accurate, an illumination intensity or compensation value would be computed (block 270) using an illumination table intensity table for use with the pixel values that are not in the border area. Alternatively, the illumination intensity could be computed using a transfer function Use of an intensity table might execute faster in real time with respect to calculating the compensated pixel values, but an intensity table would likely require a large quantity of memory. Each of the non-border pixels with the illumination intensity value may be normalized at block 272. Once the non-border pixels have been normalized, the document may be stored as compensated image data (block 274). This document is now ready for further processing, such as printing or being displayed on a video monitor screen. Further image processing might also be performed for special user needs.

An example of the illumination compensation process is now provided. First, four corner (or “near-corner”) pixels of a document as being border pixels, such as the pixels B1-B4 of FIG. 1, are identified or selected. As part of this procedure, the four corner pixels that are selected are determined to be representative of illumination variation across the document plane. In this example, their pixel values are designated V1 and V2, respectively, for the border pixels B1, B2, B3, and B4 of FIG. 1. In this example, the two top border pixels B1 and B2 have equal values V1, and the two bottom corner pixels B3 and B4 have equal illumination values V2.

The illumination intensity for a given pixel P(i,j) on the document (i.e., non-border pixels) can be estimated by an equation:
V1+j/J(V2−V1),
where J is the total number of rows of the document image. The compensation of such illumination variation reduces to normalizing the pixel values by that equation.

For example, if the pixel value V1=160 and if V2=240, a pixel in the middle of the document would theoretically have a value of 200 if the entire document was a blank document at a near-full intensity white value of 240. In this example, it can be easily seen that the four border pixels have an average value of 200, since two of them are at 160 and the other two are at 240. Thus the middle pixel would have a value of 200 assuming the variation in illumination is linear from the left margin to the right margin of such a document. (In this example, the four border pixels B1-B4 are assumed to be equidistant from the middle of the image 10. If the four border pixels B1-B4 were selected at the actual corners of a rectangular image frame, then this equidistant attribute would always be true.

If the image data comprises 8-bit data, the values will range between zero (0) and 255. Assuming all the border pixels have an ideal compensated value of 255, then the middle pixel (e.g., pixel P5 on FIG. 1) should also have a value of 255 if it was full white. If the normalized pixel value is 200, a compensation factor of 255 divided by 200, which is 1.275 is required. For example, if the middle pixel P5 had a raw pixel value of 100, then its corresponding compensated value would be 128 (rounding up) using the calculation of 100 times the compensation factor 1.275.

If none of the border pixels have the same raw value, then the situation. becomes more complex. For example, the acquired image data may have the following values for the border pixels:
B1=160,B2=175,B3=210,B4=240.
In this situation it is assumed that the illumination is not constant and that all of the border pixels should have essentially the same illumination value if they are on white paper. Therefore, the present invention will modify the effective illumination values to make them constant with respect to one another. In this example, it will be assumed that the image is a monochrome image and the image data is 8-bit data having binary values in the range of zero (0) through 255 (in base ten numbers). Another assumption is that full black equals 0, and full white equals 255.

Assuming that the white background should be at the maximum white value of 255, then each of the pixel values B1-B4 will be compensated such that their new values will be 255 for each of the four pixel locations. Since B1 had the darkest initial value, it would need to be compensated the most. Pixels B1 and B2 are found, respectively, in the upper-left and upper-right corners of FIG. 1. The image processing system can thus assume that the top portion of the image data 10 was illuminated more poorly than the bottom portions. Moreover, the pixel values for B1 and B3 also show that the left portion of the image 10 was more poorly illuminated than the right portion, which also corresponds with the B2 and B4 initial data values. Accordingly, each of the pixels that are inside the borders (i.e., pixels P1-P9) are compensated using some type of compensation table or compensation transfer function.

Using this example of FIG. 1, compensation factors can be calculated for each of the border pixels B1-B4, and as noted above, each of these values will be raised to an illumination value of 255. The factors involved to accomplish this are as follows:

| | B1 | B2 | B3 | B4 |
|---|---|---|---|---|
| RAW DATA | 160 | 175 | 210 | 240 |
| COMPENSATED DATA | 255 | 255 | 255 | 255 |
| COMPENSATION FACTORS | 1.59 | 1.46 | 1.21 | 1.06 |

The above information can be used to determine what the compensation factors should be for the non-border pixels, i.e., pixels P1-P9. It will be understood that this is a simple example and it is unlikely that actual image data will be strictly linear. However, for this example, it will be assumed that the lighting changes or light variations are essentially linear.=Therefore a linear interpolation will be used, based on the raw data values for the border pixels and their grid positions in the image array of data, as well as the grid positions of the non-border pixels P1-P9.

Using the example of FIG. 1, the border pixel values B1-B4 have raw values of 160, 175, 210, and 240, and it is assumed that they would all desirably have an ideal value at full white of 255 (assuming an 8-bit image data system). Each of the pixel values in the non-border pixels P1-P9 presumably would also have an ideal value of full white at some number greater than its raw data number, and thus, would require some type of compensation factor, or some type of additive or subtractive compensation value.

The table below lists the following types of data: [1] a White Value, which is the ideal full white value of a non-border pixel, based on its grid location on the image plane; [2] a COMP. Factor, which is a multiplicative compensation factor that may be determined by dividing 255 (i.e., the full white value) by the White Value; [3] a “RAW Value”, which equals the pixel value from the initial image data; and [4] a FINAL Value, which is the RAW Value times the COMP. Value, rounded up to an integer.

Assuming the following set of non-border data as an example:

| | Pixel Position | | | | | | | | |
|---|---|---|---|---|---|---|---|---|---|
| | P1 | P2 | P3 | P4 | P5 | P6 | P7 | P8 | P9 |
| White Value | 180.25 | 184.75 | 189.25 | 191.75 | 196.25 | 200.75 | 203.25 | 207.75 | 212.25 |
| COMP. Factor | 1.415 | 1.380 | 1.347 | 1.330 | 1.299 | 1.270 | 1.255 | 1.227 | 1.201 |
| RAW Value | 100 | 110 | 140 | 120 | 130 | 160 | 90 | 90 | 90 |
| FINAL Value | 142 | 152 | 189 | 160 | 169 | 204 | 113 | 111 | 109 |

it can be seen that the initial or RAW data pixel values have each been altered by a compensation factor. For example, the pixels P7, P8, and P9 had a final compensated value different than the RAW Value for each of those pixels. This difference is due to pixels P7, P8, and P9 being at different horizontal positions on the image data 10 and because the actual illumination was not uniform across the “page” from left-to-right on FIG. 1 when the initial image was acquired.

In the above example, it was assumed that the pixel positions in the horizontal direction for pixels P1, P4, and P7 were 10% to the right of the horizontal positions for the border pixels B1 and B3; the mid-pixels P2, P5, and P8 halfway between the horizontal positions of B1 and B3 versus B2 and B4. The right column of non-border pixels P3, P6, and P9 are assumed to be at 90% of the horizontal distance between B1, B3 versus B2, B4. In the vertical direction, the same 10%, 50%, and 90% positions are assumed along the vertical axis with respect to the border pixel positions.

The above table values are also assumed to be linear with regard to the compensation values, and in the linear case, one way of looking at these compensation values is to calculate an intermediate compensation value at each of the positions for each of the non-border pixels. This calculation begins by finding the theoretical or ideal full white value at each non-border pixel position, assuming that pixel was intended to be a full bright or full intensity pixel. This ideal full intensity pixel will be referred to as Vᵢⱼ.

Assuming compensation factors are used and this is an 8-bit system, the compensation factor for each non-border pixel would have the form of the value 255 divided by the value for Vij. This compensation factor can be referred to as Cij. Assuming each raw data value of the non-border pixels is the variable Pij, then the final compensated pixel values would be Pij times Cij.

It will be understood that the ideal compensation values discussed in the above examples have always been set to a value of 255, which was considered to be the ideal (or maximum) brightness for a full-intensity white pixel, or for a full intensity pixel of any of the primary colors that might be involved for a particular color plane. However, this full-white assumption does not necessarily have to apply, particularly if it is known in advance that the document being imaged is on some type of paper that is not necessarily white, or at least not bright white. For example, if the document is known to be a parchment historical document, and the parchment paper is substantially yellow, or even perhaps yellow brown, then it may be decided by the user that the full bright or full intensity value should be something less than 255, such as 220, for example. In that situation, then the border pixel values might be compensated to a value somewhere in the range of 220 through 255, as desired by the system designer, and the non-border pixels might then only be compensated to 220 in that example. This, of course, is a refinement of the present invention, but the calculation burden for this type of alternative amount of compensation is really not much greater than assuming that the full bright value of 255 would be used. However, there would need to be some way of inputting this information into the processing unit that is performing these calculations. If a PC is used, then the compensation software could offer this as an attribute that could be entered by the user at the keyboard. It could even be an optional value that a user could enter through the op-panel of a printer, for example.

It should be noted that much of the control logic needed for controlling the functions of the printing process and the sheet media movements of a printer can be off-loaded to a physically separate processing circuit, or to a virtual processing device. For example, a host computer could send appropriate command signals directly to output switching devices (e.g., transistors or triacs) that reside on the printer main body. The host computer could also directly receive input signals from various sensors on the printer main body to facilitate the control logic that is resident on such a host computer. Thus, the control logic (or a portion thereof) of a printing device need not always be part of the physical printer, but may be resident in another physical device. The control may also be virtual. In reference to FIG. 4, the microprocessor 76 may not reside within the printer 70 but instead could be replaced by a set of electrical or optical command signal-carrying and data signal-carrying pathways (e.g., a set of parallel electrical conductors or fiber optic channels).

It will be understood that the methodology of the present invention is applicable to all types of printers (e.g., laser printer, ink jet printers and multi-function devices capable of printing) and all types of digital image-acquiring devices (e.g., digital still cameras, digital movie cameras and scanners). Moreover, a three-dimensional image acquiring system can be used to acquire the initial image data, and a single frame can be selected from that type of data and then be compensated for non-uniformities in its illumination when the frame was acquired.

It will also be understood that the term print media as used herein refers to a sheet or roll of material that has toner or some other printable material applied thereto by a print engine, such as that found in a laser printer or other type of electrophotographic printer. Alternatively, the print media may represent a sheet or roll of material that has ink or some other printable material applied thereto by a printhead, such as that found in an ink jet printer, or which is applied by another type of printing apparatus that projects a solid or liquified substance of one or more colors from nozzles or the like onto the sheet or roll of material. Print media is sometimes referred to as “print medium,” and both terms have the same meaning with regard to the present invention. Print media can represent a sheet or roll of plain paper, bond paper, transparent film (often used to make overhead slides, for example), or any other type of printable sheet or roll material.

It will further be understood that the logical operations described in relation to the flow charts of FIGS. 5 and 6 can be implemented using sequential logic, such as microprocessor technology, or a logic state machine, or perhaps by discrete logic. In some embodiments of the present invention, the logical operations may be implemented using parallel processors. One exemplary embodiment may use a microprocessor or microcontroller (e.g., microprocessor 76) to execute software instructions that are stored in memory cells within an ASIC. The entire microprocessor 76, along with dynamic RAM and executable ROM may be contained within a single ASIC in one mode of the present invention. Other types of circuitry could be used to implement these logical operations depicted in the drawings without departing from the principles of the present invention, as would be understood by one skilled in the art.

It will be yet further understood that the precise logical operations depicted in the flow charts of FIGS. 5-6, and discussed above, could be somewhat modified to perform similar, although not exact, functions without departing from the principles of the present invention. The exact nature of some of the decisions and other commands in these flow charts are directed toward specific models of printer systems but certainly similar actions may be taken for use with other printing systems in many instances with the overall inventive results being the same.

All documents cited in the Detailed Description are, in relevant part, incorporated herein by reference The citation of any document should not to be construed as an admission that it is prior art with respect to the present invention.

The foregoing description of a preferred embodiment of the invention has been presented for purposes of illustration and description. It is not intended to be exhaustive or to limit the invention to the precise form disclosed. Any examples described or illustrated herein are intended as non-limiting examples, and many modifications or variations of the examples, or of the exemplary embodiment(s), are possible in light of the above teachings, without departing from the spirit and scope of the present invention. The embodiment(s) was chosen and described in order to illustrate the principles of the present invention and its practical application to thereby enable one of ordinary skill in the art to utilize the invention in various embodiments and with various modifications as are suited to particular uses contemplated. It is intended that the appended claims cover all such changes and modifications that are within the scope of this present invention.

What is claimed is:

1. A method for compensating two-dimensional image data, comprising:
receiving an initial image comprising two-dimensional image data, and determining a first set of data that comprises a first plurality of pixels at various grid locations within a first region of said two-dimensional image data;
analyzing said first set of data for variations in illumination values of the first plurality of pixels, and determining relative non-uniformities of intensity in said first set of data, based upon said illumination values;
determining a set of initial compensation data used in correcting for said relative non-uniformities of intensity in said first set of data, wherein said set of initial compensation data includes both intensity correction values and corresponding grid location information for at least a portion of said first set of data; and
applying said set of initial compensation data to said two-dimensional data, including second portions of said two-dimensional data that are not part of said first set of data, using only information based upon said initial image.

2. The method as recited in claim 1, wherein said applying said set of initial compensation data to said two-dimensional data comprises:
using said initial compensation data for all grid locations of said first set of data;
extrapolating said initial compensation data into a second set of compensation data for grid locations of said second portions of the two-dimensional data; and
using said second set of compensation data for all grid locations of the entire two-dimensional image data that are not part of said first set of data.

3. The method as recited in claim 1, wherein said initial compensation data and said second set of compensation data comprises various numeric values that are calculated for various grid locations of the two-dimensional image data.

4. The method as recited in claim 1, wherein at least one of said receiving an initial image comprising two-dimensional image data, said analyzing said first set of data, said determining a set of initial compensation data, and said applying said set of initial compensation data to said two-dimensional data is performed by at least one of a two-dimensional image-acquiring device, an image-forming apparatus; and a computer apparatus.

5. The method as recited in claim 4, wherein said two-dimensional image-acquiring device comprises a digital camera and said image-forming apparatus comprises a printer.

6. The method as recited in claim 1, wherein said first region comprises a border portion of said two-dimensional image data, said second portions of said two-dimensional data are in a non-border portion.

7. The method as recited in claim 1, wherein said first region comprises a background portion of said two-dimensional image data and said second portions of said two-dimensional data are in a non-background portion.

8. The method as recited in claim 1, wherein said determining a first set of data includes determining locations of said first plurality of pixels within said first region of said two-dimensional image data by:
taking a sample of n pixels of said initial image, and determining an average value of an intensity of said n pixels;
inspecting m pixels located proximal to at least one edge of said initial image, and determining if an intensity of each of said m pixels is less than said average value, and if so, storing a pixel location for such pixels; and
from said pixel locations of said initial image that have an intensity less than said average value, determining an image grid boundary of such pixel locations.

9. A method for compensating two-dimensional image data, comprising:
receiving an initial image comprising two-dimensional image data and determining locations of a first plurality of pixels for a border region of said initial image;
determining illumination non-uniformities of said first plurality of pixels based upon variations in image data intensity values of said first plurality of pixels;
determining compensation data for a second plurality of pixels, located in a non-border region of said initial image, based upon said illumination non-uniformities of said first plurality of pixels; and
applying said compensation data to said second plurality of pixels to create a third plurality of pixels that are substantially compensated for non-uniformities in illumination of said initial image using only information based upon said initial image.

10. The method as recited in claim 9, wherein said determining locations of a first plurality of pixels for a border region of said initial image comprises:
taking a sample of n pixels of said initial image, and determining an average value of an intensity of said n pixels;
inspecting m pixels located proximal to at least one edge of said initial image, and determining if an intensity of each of said m pixels is less than said average value, and if so, storing a pixel location for such pixels; and
from said pixel locations of said initial image that have an intensity less than said average value, determining an image grid boundary of such pixel locations, thereby substantially determining an estimated area of said initial image that makes up said border region.

11. The method as recited in claim 9, wherein said border region comprises one of areas along four edges of a four-sided image area that make up said initial image and areas along three edges of a four-sided image area that make up said initial image.

12. The method as recited in claim 9, wherein said determining illumination non-uniformities of the first plurality of pixels comprises:
using said first plurality of pixels, comparing an actual pixel intensity value to an estimated desired intensity value;
determining a difference between those values; and
storing said difference values and their corresponding pixel locations.

13. The method as recited in claim 9, wherein said determining compensation data for the second plurality of pixels comprises:
calculating a two-dimensional function that may describe said illumination non-uniformities of the first plurality of pixels;
attempting to fit said two-dimensional function to actual pixel intensity values of the first plurality of pixels and determining whether said fit is sufficiently accurate;
if said fit is not sufficiently accurate, re-calculating a different form of said two-dimensional function; and
if said fit is sufficiently accurate, determining said compensation data for the second plurality of pixels using said sufficiently accurate two-dimensional function.

14. The method as recited in claim 9, further comprising printing a document using said third plurality of pixels.

15. The method as recited in claim 9, wherein at least one said receiving an initial image comprising two-dimensional image data, said determining locations of a first plurality of pixels for a border region of said initial image, said determining illumination non-uniformities of said first plurality of pixels, said determining compensation data for a second plurality of pixels located in a non-border region of said initial image, and said applying said compensation data to said second plurality of pixels are performed by at least one of a two-dimensional image-acquiring device, an image-forming apparatus, a computer apparatus.

16. The method as recited in claim 15, wherein said two-dimensional image-acquiring device comprises a digital camera and said image-forming apparatus comprises a printer.

17. The method as recited in claim 10, wherein said inspecting m pixels located proximal to at least one edge of said initial image comprises one of:
inspecting each pixel position along each image grid row and column proximal to an edge of said initial image;
inspecting a random sample of patterns and numbers of pixel positions along each image grid row and column proximal to an edge of said initial image; and
inspecting a predetermined, non-random sample of patterns and numbers of pixel positions along each image grid row and column proximal to an edge of said initial image.

18. The method as recited in claim 13, wherein said two-dimensional function that describes said illumination non-uniformities of the first plurality of pixels comprises a Taylor polynomial and said attempting to fit said two-dimensional function to actual pixel intensity values of the first plurality of pixels comprises increasing a complexity of said Taylor polynomial as required to achieve said sufficiently accurate fit.

19. A method for compensating two-dimensional image data, comprising:
receiving an initial image comprising two-dimensional image data, and determining first compensation data for a border region of said initial image;
determining second compensation data for a non-border region of said initial image, by extrapolating said first compensation data into said non-border region; and
applying said first compensation data to said border region, and applying said second compensation data to said non-border region, to thereby substantially compensate for non-uniformities in illumination of all portions of said initial image, using only information based upon said initial image.

20. The method as recited in claim 19, wherein said determining second compensation data for a non-border region of said initial image comprises:
calculating a two-dimensional function that may describe said illumination non-uniformities of a first plurality of pixels in said border region;
attempting to fit said two-dimensional function to actual pixel intensity values of the first plurality of pixels, and determining whether said fit is sufficiently accurate;
if said fit is not sufficiently accurate, re-calculating a different form of said two-dimensional function; and
if said fit is sufficiently accurate, determining said compensation data for a second plurality of pixels in a non-border region of said initial image, using said sufficiently accurate two-dimensional function.
